(19) United States
(12) Patent Application Publication
(10) Pub. No.: US 2026/0166726 A1
(43) Pub. Date: Jun. 18, 2026

(54) AUTONOMOUS/REACTIVE HUMAN-ROBOTIC MIMETIC HAPTIC CONTROL FRAMEWORK

(71) Applicant: Arizona Board of Regents on Behalf of the University of Arizona, Tucson, AZ (US)

(72) Inventors: Wolfgang Fink, Tucson, AZ (US); Mark Tarbell, Tucson, AZ (US)

(21) Appl. No.: 19/418,578

(22) Filed: Dec. 12, 2025

Related U.S. Application Data
(60) Provisional application No. 63/733,408, filed on Dec. 12, 2024.

(51) Int. Cl. B25J 9/16; G05B 19/423

(52) U.S. Cl. CPC B25J 9/163; G05B 19/423; G05B 2219/32335; G05B 2219/39001

(57) ABSTRACT

Various examples are provided related to an autonomous/reactive human-robotic mimetic haptic control framework. In one example, a system includes at least one sensor obtaining tool operation data associated with a user operating a hand tool during execution of a construction process; and at least one computing device that trains a robotic system to mimic operation of the hand tool based upon the tool operation data; and causes the robotic system to carry out the operation using the hand tool by performing at least a portion of one or more trained behavior motif, each trained behavior motif including a time-stamped list of defined execution steps.

### CROSS REFERENCE TO RELATED APPLICATIONS

This application claims priority to, and the benefit of, U.S. provisional application entitled “Autonomous/Reactive Human-Robotic Mimetic Haptic Control Framework” having Ser. No. 63/733,408, filed Dec. 12, 2024, which is hereby incorporated by reference in its entirety.

This application is related to International Application Serial No. PCT/US24/37851, filed Jul. 12, 2024, which claims priority to, and the benefit of, U.S. provisional application entitled “Human-Robotic Mimetic Haptic Control Framework” having Ser. No. 63/526,771, filed Jul. 14, 2023, both of which are hereby incorporated by reference in their entireties.

### BACKGROUND

There are ˜126 million buildings in the United States. These buildings consume ˜74% of the nation's electricity, are responsible for ˜35% of its CO₂ emissions from energy consumption and use ˜39% of its total energy. These buildings will remain in operation and continue to contribute significantly to carbon emissions even if all new buildings are made carbon neutral. As such, the Department of Energy (DOE) has identified building envelope retrofitting as a major opportunity to significantly reduce the energy and emission footprint of the nation's building infrastructure.

### SUMMARY

Aspects of the present disclosure are related to an autonomous/reactive human-robotic mimetic haptic control framework. In one aspect, among others, a system for autonomous/reactive human-robotic mimetic haptic control comprises: at least one sensor obtaining tool operation data associated with a user operating a hand tool during execution of a construction process; and at least one computing device configured to: train a robotic system to mimic operation of the hand tool based upon the tool operation data; and cause the robotic system to carry out the operation using the hand tool by performing at least a portion of one or more trained behavior motif, each trained behavior motif comprising a time-stamped list of defined execution steps. The portion of the first trained behavior motif can be a first portion of the first trained behavior motif and the portion of the second trained behavior motif can be a first portion of the second trained behavior motif. The portion of the first trained behavior motif can be a first portion of the first trained behavior motif and the portion of the second trained behavior motif can be a second portion of the second trained behavior motif. The portion of the first trained behavior motif can be a second portion of the first trained behavior motif and the portion of the second trained behavior motif can be a first portion of the second trained behavior motif. The portion of the first trained behavior motif can be a second portion of the first trained behavior motif and the portion of the second trained behavior motif can be a second portion of the second trained behavior motif. The portion of the first trained behavior motif can be executed at a first speed and the portion of the second trained behavior motif can be executed at a second speed. Discontinuous portions of one or more trained behavior motif can be performed. At least a portion of a first trained behavior motif can be inverted prior to being performed. One or more portion of the first trained behavior motif can be exchanged with one or more portion of the second trained behavior motif. The exchanged portions can be or may not be in corresponding positions in the first and second trained behavior motifs. At least one of the exchanged portions can be reordered in at least one of the first and second trained behavior motifs. Various portions of a first trained behavior motif can be (1) executed or omitted, (2) can be executed at various speeds respectively, (3) can be inverted, (4) can be shuffled, i.e., the order of the various portions of a first trained behavior motif can be changed, (5) any combination of the above, etc. Additionally, one or more portion of a first trained behavior motif can be exchanged/swapped with one or more portion of a second trained behavior motif. Moreover, one or more portion of a first trained behavior motif can be exchanged/swapped with one or more portion of a second trained behavior motif but, in addition, modified according to any modalities listed above.

In various aspects, the at least one computing device can be configured to: identify a behavior motif associated with movement or motion of the hand tool during execution of the operation based upon the tool operation data; and train the robotic system to execute the behavior motif using the hand tool. The behavior motif can comprise movement of the hand tool in three dimensions over a period of time. Execution of the behavior motif can comprise application of a force or pressure through the hand tool. In other aspects, the at least one computing device can be configured to: identify at least a portion of one or more behavior motifs associated with movement or motion of the hand tool during execution of the operation based upon the tool operation data; and train the robotic system to execute the at least a portion of one or more behavior motifs using the hand tool. The operation can comprise application of a surface coating. The at least a portion of one or more trained behavior motifs can be modified in response to a comparison of at least a current modality or characteristic of the surface coating with a target modality or characteristic of the surface coating. The modification of the at least a portion of one or more trained behavior motifs can be effectuated using a stochastic optimization framework. The system can comprise a monitoring system configured to provide feedback for the comparison, the feedback associated with a modality or characteristic of the surface coating. The at least a portion of one or more trained behavior motifs can be modified in response to a comparison of at least a current modality or characteristic of the construction process with a target modality or characteristic of the construction process. The system can comprise a monitoring system configured to provide feedback for the comparison, the feedback associated with a modality or characteristic of the construction process.

In another aspect, a method for autonomous/reactive human-robotic mimetic haptic control, comprises obtaining tool operation data associated with a user operating a tool during execution of an application process; and training a robotic system to mimic operation of the tool based upon the tool operation data. In one or more aspects, the application process can be a construction process. The tool can be a hand tool. The tool can comprise at least one sensor configured to monitor the spatial trajectory of the tool during execution of the application process. The spatial trajectory can be recorded.

In various aspects, the tool can comprise at least one sensor configured to monitor the 3D attitude of the tool during execution of the application process. The 3D, 2D, or 1D attitude can be recorded. The tool operation data can be communicated to at least one computing device for training the robotic system. The robotic system can be trained using an artificial intelligence (AI) system. It should be noted that AI is a vast field of study that encompasses many different techniques, algorithms, and methodologies. The question of whether it is “more” about Mamdani rules, i.e., “IF-THEN” rules, or artificial neural networks addresses two fundamentally different, yet sometimes complementary, approaches to achieving machine intelligence and/or machine learning. However, modern artificial intelligence, particularly the dominant paradigm today, is vastly more associated with artificial neural networks and their derivatives than with Mamdani rules. The AI system can comprise an artificial neural network, a single layer or multi-layer feedforward network, a recurrent network, a convolutional network, a deep learning neural network, or another machine learning and/or machine intelligence system (e.g., systems or expert systems based on Mamdani/“IF-THEN” rules). The robotic system can play back the tool operation. In some aspects, the method can comprise utilizing the trained robotic system to perform the application process. The application process can comprise, for example, application of at least a portion of an exterior insulation and finish system.

In another aspect, a system for autonomous/reactive human-robotic mimetic haptic control comprises at least one sensor obtaining tool operation data associated with a skilled user operating a hand tool during execution of a construction process; and at least one computing device configured to train a robotic system to mimic operation of the hand tool based upon the tool operation data. In one or more aspects, the construction process can comprise, for example, application of a surface coating. The at least one computing device can be further configured to cause the robotic system to apply the surface coating by performing one or a combination of trained behavior motifs using the hand tool. The combination of trained behavior motifs can be modified in response to a comparison of at least a current modality or characteristic of the surface coating with a target modality or characteristic of the surface coating. The modification of the combination of trained behavior motifs can be effectuated using a stochastic optimization framework. The system can comprise a monitoring system configured to provide feedback associated with at least a modality or characteristic of the surface coating. The monitoring system can comprise a mono-camera, stereo-camera, or multi-camera monitoring system. The mono-camera, stereo-camera, or multi-camera monitoring system can operate in at least one of the following spectral ranges: UV, Visible, IR. The modality or characteristic can be, for example, a texture of the surface coating.

In various aspects, the at least one sensor can be configured to monitor position and orientation of the hand tool during execution of the construction process. The at least one sensor can comprise an imaging device configured to obtain a series of images of the hand tool during execution of the construction process. The hand tool can comprise a pressure or force sensor. The at least one computing device can be configured to: identify a behavior motif associated with movement or motion of the hand tool during execution of the construction process based upon the tool operation data; and train the robotic system to execute the behavior motif using the hand tool. Execution of the behavior motif can comprise movement of the hand tool in three dimensions over a period of time. Execution of the behavior motif can comprise application of a pressure or force through the hand tool.

In some aspects, the at least one computing device can be configured to: identify a plurality of behavior motifs associated with movement or motion of the hand tool during execution of the construction process based upon the tool operation data; and train the robotic system to execute each of the plurality of behavior motifs using the hand tool. Execution of the construction process can comprise a combination of the plurality of behavior motifs. In one or more aspects, the at least one computing device can train an artificial intelligence (AI) system to cause the robotic system to execute the behavior motif using the hand tool. The AI system can comprise an artificial neural network, a single layer or multi-layer feedforward network, a recurrent network, a convolutional network, a deep learning neural network, or another machine learning system. The AI system can be trained with a stochastic optimization framework.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A illustrates examples of in-field application of insulation and finish coatings of an exterior insulation and finish system (EIFS), in accordance with various embodiments of the present disclosure.

FIG. 1B illustrates examples of in-plant application of insulation and finish coatings of an EIFS, in accordance with various embodiments of the present disclosure.

FIG. 2 illustrates examples of manual (left) and robotic (right) EIFS application, in accordance with various embodiments of the present disclosure.

FIG. 3 illustrates an example of a stochastic optimization framework (SOF), in accordance with various embodiments of the present disclosure.

FIGS. 4A-4E illustrates an example of a tool (e.g., a trowel) comprising an onboard micro-computer platform and sensors for monitoring, recording, and documenting tool operations, in accordance with various embodiments of the present disclosure.

FIG. 5A illustrates an example of spatial movement and attitude changes of a trowel during trowel operations, in accordance with various embodiments of the present disclosure.

FIG. 5B illustrates a graphical display of the three Euler angles that represent the 3D orientation/attitude of a trowel during trowel operations, in accordance with various embodiments of the present disclosure.

FIG. 6A illustrates degrees of freedom (DOFs) of a robotic arm controlled by, e.g., an artificial neural network, a single layer or multi-layer feedforward network, a recurrent network, a convolutional network, or a deep learning neural network, in accordance with various embodiments of the present disclosure.

FIG. 6B illustrates examples of x/y/z gantry stages to which a robotic arm can be attached, in accordance with various embodiments of the present disclosure.

FIG. 6C illustrates examples of robotic hands as potential end effectors of a robotic arm to robotically execute trowel operations, thus mimicking a human hand or a human operator/skilled worker.

FIG. 6D illustrates an example of an industrial rolling pin which potentially can be used for even distribution of EIFS coating material on panels (FIG. 1B) before fine-tuning troweling operations commence, in accordance with various embodiments of the present disclosure.

FIG. 7A illustrates an example of a sensor and micro-computer equipped data glove (right) to control a robotic arm (left) wirelessly to teach trowel operations, in accordance with various embodiments of the present disclosure.

FIG. 7B illustrates an example of a freedrive mode of a robotic arm in which a user can teach the robotic arm different trajectories, spatial attitudes, and/or operations, in accordance with various embodiments of the present disclosure.

FIGS. 8A-8D illustrate examples of camera monitoring systems that can be used for identification of surface textures using, e.g., Gabor or other applicable/suitable filters, in accordance with various embodiments of the present disclosure.

FIG. 9 illustrates an example definition of Euler angles, in accordance with various embodiments of the present disclosure.

FIG. 10 is a schematic diagram illustrating an example of a computing (or processing) device that can be used for the autonomous/reactive human-robotic mimetic haptic control framework or other applications, in accordance with various embodiments of the present disclosure.

### DETAILED DESCRIPTION

Disclosed herein are various examples related to an autonomous/reactive human-robotic mimetic haptic control framework. Reference will now be made in detail to the description of the embodiments as illustrated in the drawings, wherein like reference numbers indicate like parts throughout the several views.

Due to the variations in how buildings are built in different climates, with different materials, and with different sizes and shapes, building envelope retrofitting is a highly customized, labor intensive, largely manual process that is difficult to reduce to a one-size-fits-all approach. The application of continuous exterior insulation can significantly increase the thermal performance of existing and new buildings in all US and worldwide climate zones. When applied correctly, continuous exterior insulation works by reducing the effects of thermal bridging in existing wall assemblies and reducing or eliminating the risk of moisture damage from condensation, bulk water leakage, and uncontrolled air movement through the wall assembly. Reducing air leakage, also referred to as increasing airtightness or reducing air infiltration, is another effective strategy to reduce energy usage of existing buildings. Because air is energetically expensive to condition, airtightness measures are especially effective for smaller buildings in extreme climates.

In the US, the low cost of energy has often made energy retrofits economically unpalatable. However, building owners across the commercial and residential sectors regularly invest large sums into improving the aesthetic quality of existing buildings to increase the value of buildings that appear worn or dated, but otherwise retain functional utility. Due to the individualism in how buildings are built (i.e., the shape of the building envelope), envelope retrofitting and the application of insulation and finish systems for buildings such as, e.g., exterior insulation and finish systems (EIFS), are highly labor-intensive, largely manual processes. The applications can also include extra-terrestrial building processes. For example, this methodology can also be applied to the construction of space habitats on planetary bodies, such as the Moon, Mars, asteroids, comets, etc. as well as in caves, in lava tube caves, subsurface cavities, etc. Additional applications can also include both terrestrial and extra-terrestrial subsurface aquatic/liquid building processes. For example, this methodology can also be applied to the construction of habitats on ocean floors on Earth as well as on extra-terrestrial ocean worlds, such as Europa and Titan, etc. Here construction or building process can refer to, but is not limited to, surface coating, application of exterior insulation and finish system (EIFS), building brick walls, masonry work, molding (e.g., clay), carving or chiseling (e.g., wood, stone, ice, etc.), industrial and artistic painting, spraying/coating, welding, etc.

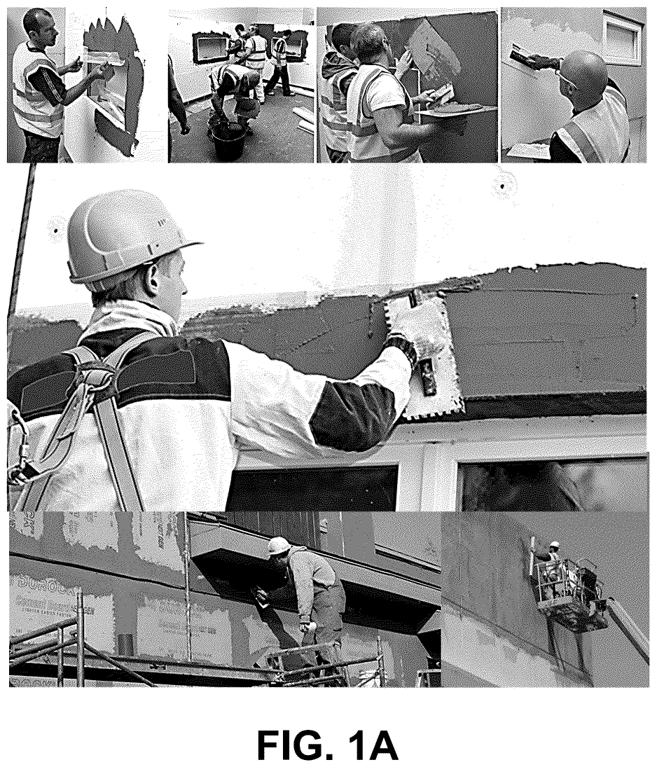

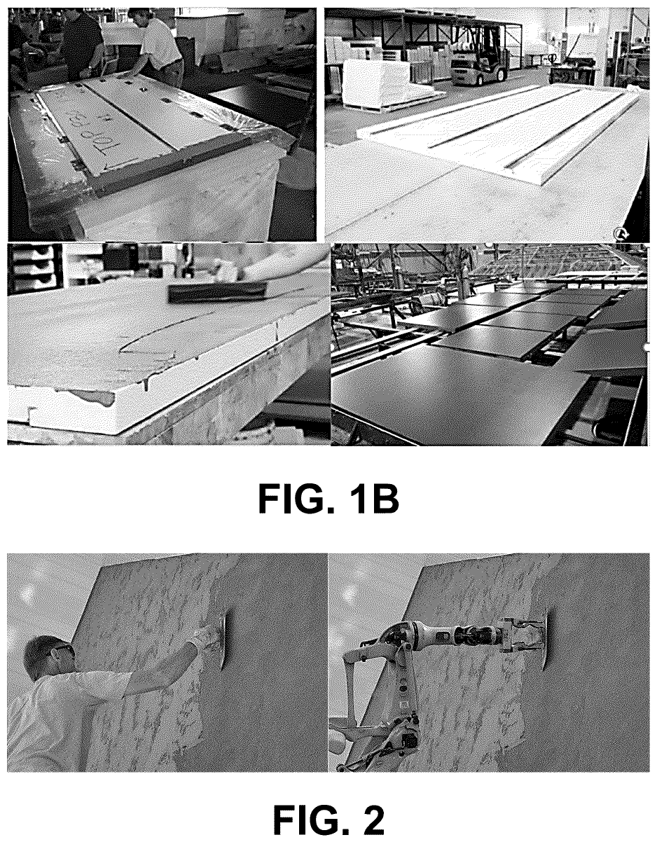

Exterior Insulation and Finish System (EIFS) is a process to insulate walls of buildings and to either restore, upgrade, or alter their appearance. It is a highly labor-intensive, manual process. EIFS can be performed in two modalities:
In-field as illustrated in the images of FIG. 1A: skilled workers or artistic operators work alongside building facades and apply the insulation and finish coatings of an exterior insulation and finish system (EIFS) manually with trowels. This process is temperature-dependent as it has to be performed in about 0 degrees Celsius or greater in order for the coating formulations to stay liquid and is somewhat weather and/or climate dependent, e.g., humidity dependent.
In-plant as illustrated in the images of FIG. 1B: in this modality pre-fabricated panels of varying sizes (can be as large as having to be transported by semis and cranes) are coated in-house, e.g., inside a fabrication hall. While this process is largely weather (e.g., humidity) and temperature independent, the application of EIFS (i.e., coatings and finish) is still applied manually with trowels.
   Both modalities are labor-intensive processes subject to skilled, artistic labor performed with tools, such as a trowel. There is a desire in the industry to automate as many steps as possible. In particular, automation of the manufacturing of insulation and finish panels for EIFS applications can significantly reduce manual labor, production time, and cost, as well as potentially mitigate a diminishing labor force. It should be mentioned that especially in the case of space habitats or subsurface ocean habitats (but also in the case of terrestrial surface operations), the methodology described here may also be pressure dependent as it would affect, e.g., the viscosity or density of the coating material, etc. The viscosity or density of the coating material determines, at least in part, how easy or hard it is to apply and manipulate the coating material.

While there may be some degree of automation by pre-coating panels with insulation material, the final touches of the finish-coating are often subject to skilled, artistic labor performed with a trowel. An autonomous/reactive human-robotic mimetic haptic control framework offers a way to subject the finishing step to automation by robotically learning the complex movements of a trowel in the hands of an actual skilled worker or artistic operator to result in an autonomous/reactive robotic troweling system in this particular application. FIG. 2 illustrates an example of the transition from a manual application (left) to a robotically automated application (right). While smooth or planar surfaces are depicted in FIG. 2, the robotically automated application can also be extended to non-smooth surfaces, corners or other angled surfaces, as well as to curved surfaces.

The autonomous/reactive human-robotic mimetic haptic control framework can include recording the complex tool movements performed by a human operator, skilled worker, or artistic operator in 3D, and translating the movements onto a robotic stage or arm equipped with the same or similar tool(s). The same, or similar, or optimized movements can then be performed according to the recorded movements or according to extracted or learned motifs of the recorded movements. The translation of the recorded movements onto the robotic stage or arm can be performed via training of artificial intelligence (AI) systems, such as, e.g., artificial neural networks, single layer or multi-layer feedforward networks, recurrent networks, convolutional networks, deep learning neural networks, or other machine learning systems, or through forward kinematics or inverse kinematics, potentially optimized via, e.g., a stochastic optimization framework or other multi-variate optimization algorithm or framework, to automate the EIFS process for in-plant panel production.

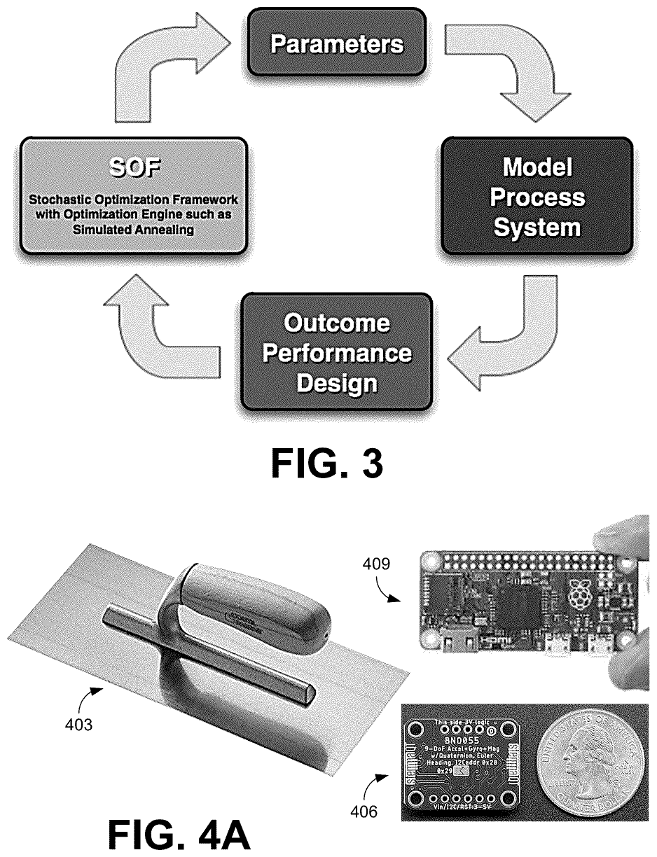

FIG. 3 illustrates a functional schematic of a Stochastic Optimization Framework (SOF); see, e.g., “Stochastic Optimization Framework (SOF) for Computer-Optimized Design, Engineering, and Performance of Multi-Dimensional Systems and Processes” by W. Fink (Proc. SPIE, Vol. 6960, 69600N (2008); DOI:10.1117/12.784440 (invited paper)). A SOF efficiently samples the parameter space associated with a model, process, or system (1) by repeatedly running the model, process, or system in a forward fashion, and (2) by comparing the respective outcomes against a desired outcome, the difference or deviation of which results in a fitness measure. The goal of the SOF is to optimize (e.g., minimize) this fitness by using multi-dimensional optimization algorithms, such as, but not limited to, Simulated Annealing or Genetic Algorithms or Evolutionary Algorithms, as well as Marquardt-Levenberg-type algorithms, as the optimization engine to determine optimal parameter values. One way to determine optimal parameter values is to analytically invert models, processes, or systems, or to run them backwards. However, in many cases—as is the case with robotic joint angle optimization—this is analytically or practically infeasible due to the inherent complexity and high degree of nonlinearity. A SOF overcomes this problem, by effectively “inverting” these models, processes, or systems to determine parameter values that, when applied, yield the desired outcomes, or approximate them as closely as possible, for example, within a certain user-defined accuracy or tolerance.

To implement an automated process, the autonomous/reactive human-robotic mimetic haptic control framework can facilitate learning of the operations by, e.g., recording of complex tool movements performed by a human operator, skilled worker, or artistic operator and translation of these recorded movements onto a robotic arm and/or stage. The autonomous/reactive human-robotic mimetic haptic control framework can also address automation of EIFS on panels for “in-plant” manufacturing with a desired surface texture and application of the same automation process for “in-field” settings.

### Recording of Complex Tool Movements Performed by a Human Operator, Skilled Worker, or Artistic Operator in 3D Overtime

Next, recording the movements in 3D space over time of a hand-held tool performed by a human operator or skilled worker/expert/artistic operator is examined. While this is a generic approach, applicable to many scenarios and applications, the following focuses, as an example, on the 3D movement of a trowel by a human operator, skilled worker, or artistic operator to apply insulation and finish coatings (e.g., EIFS) on horizontally placed panels. By extension, this would apply to building facades as well, i.e., vertical orientation of panels as well as other orientations.

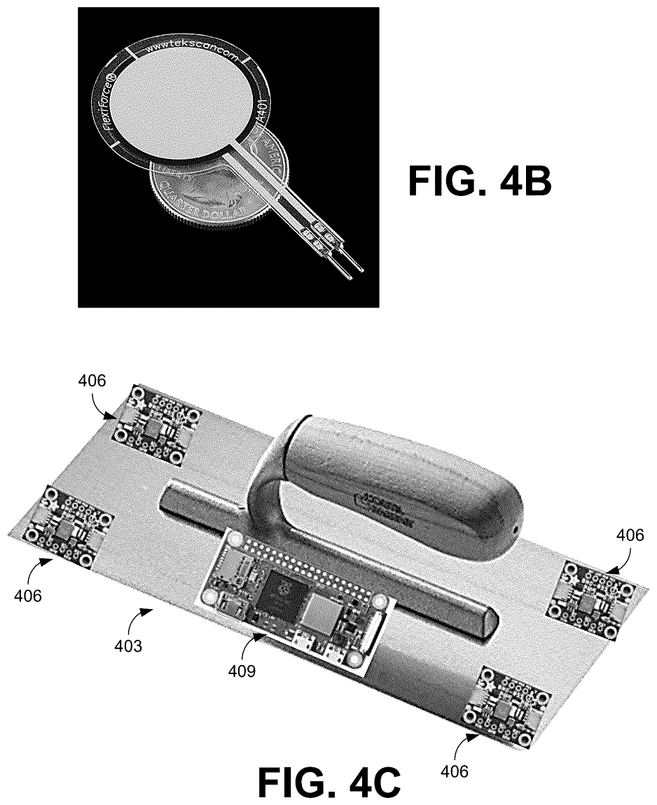

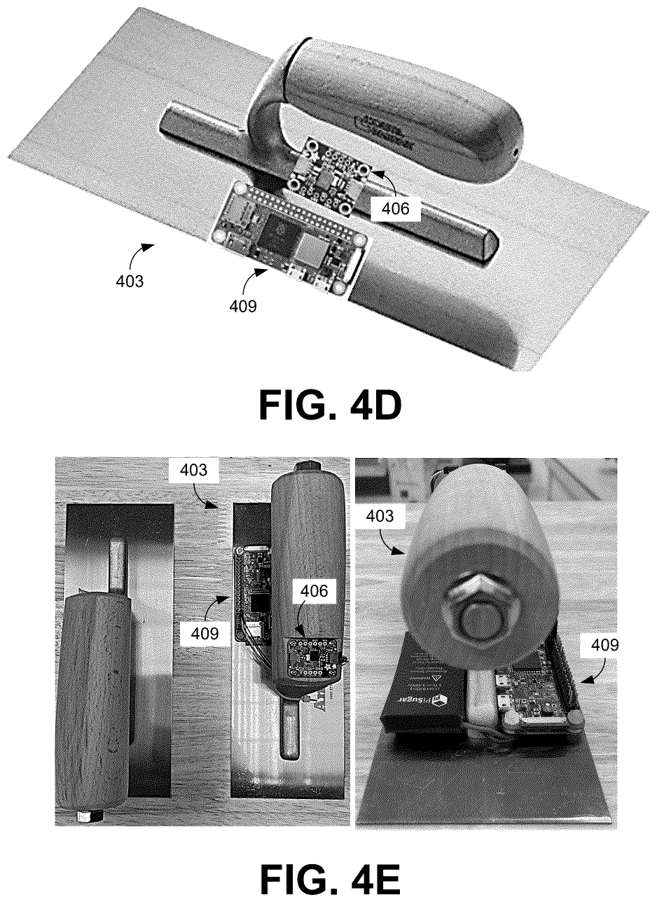

In order to track the three-dimensional (3D) movement and spatial attitude of a hand tool (e.g., a hand-held trowel) over time during the application of, e.g., insulation and finish coatings (e.g., EIFS) on a panel, the hand tool can be equipped with sensors coupled to processing circuitry such as, e.g., a microcontroller or micro-computer. The images of FIG. 4A illustrate an example of a standard trowel 403 that can be equipped, e.g., with one or more inertial measurement unit (IMU) 406 sensors connected to processing circuitry 409, e.g., a battery-powered Raspberry Pi Zero micro-computer. FIG. 4B shows an example of a pressure sensor or sensing device that can be used with the tool. In another example, at least one of a mechanical moment sensing, torque sensing, or force sensing module or sensor, such as a load cell, can be used with the tool. FIGS. 4C and 4D illustrate examples with four IMUs 406 located, for example, at the corners of a trowel 403 and one IMU 406 centrally located on the trowel 403, respectively. The IMUs 406 would record rotational, i.e., around x-/y-/z-axes, and translational movements in 3D space of the trowel 403 during the EIFS-process. In one instantiation, the IMUs 406 would record Euler angles around the x-/y-/z-axes, and through integration over time, would record the translational movements of the trowel 403 in 3D space. FIG. 4E shows a fully integrated, autark/self-sufficient trowel 403 with centrally placed IMU 406, and battery-powered micro-processor 409, i.e., Raspberry Pi Zero micro-computer in this example.

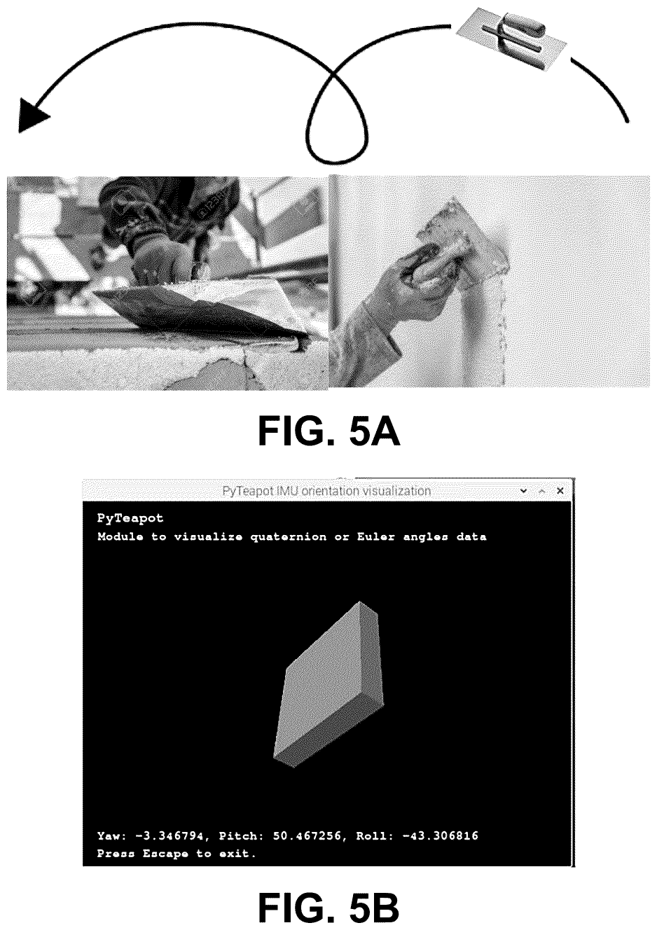

The operation of the so-equipped trowel during the EIFS process by a human operator, skilled worker, or artistic operator will result in spatial trajectories and positions in addition to 3D attitude and/or orientation information about the trowel, such as, but not limited to, angle with respect to the surface of the panel to be coated with insulation and finish coatings (e.g., EIFS). FIG. 5A illustrates examples of a spatial trajectory and 3D attitude and/or orientation of the trowel. The use of more than one IMU 406 may allow for trajectory averaging to reduce noise, to increase accuracy, and/or to increase redundancy/robustness. As shown in FIGS. 4D and 4E, a single IMU 406 can be used as well, in which case it may be beneficially placed at the center of the trowel, i.e., at the pivoting point of the trowel handle. In another example, at least one GPS sensor can be used to record/track the spatial trajectory and position of the trowel.

Other sensor modalities are envisioned as well, such as, but not limited to, one or more force or pressure sensor(s), temperature or thermal sensor(s), moisture/humidity sensor(s), and/or viscosity or density sensor(s), e.g., to assess/measure the viscosity or density of the coating material or coating surface. To measure and/or record force or pressure exerted on the trowel by the human operator, skilled worker, or artistic operator during trowel operations, one or more force or pressure sensor(s) or sensing device(s), mechanical moment sensor(s) or device(s), torque sensor(s) or device(s), or force sensing module(s) or sensor(s) can be incorporated, e.g., in the handle of the trowel, the shaft that connects the handle to the blade, on the blade (e.g., the surface-facing underside) of the trowel, or any combination thereof. In some implementations, the trowel can be equipped with one or more moisture or humidity sensor(s) (e.g., on the surface-facing underside) to measure and/or record the wetness/moisture/humidity, or changes thereof, of the coating material or coating surface before, during, and after manipulation through the trowel. In some other implementations, the trowel can be equipped with one or more temperature or thermal sensor(s) (e.g., on the surface-facing underside) to measure and/or record the temperature, or changes thereof, of the coating material or coating surface before, during, and after manipulation through the trowel. In yet some other implementations, the trowel can be equipped with one or more viscosity or density sensor(s) (e.g., on the surface-facing underside) to measure and/or record the viscosity or density, or changes thereof, of the coating material or coating surface before, during, and after manipulation through the trowel. The gathered information of the above and other sensor modalities can be communicated from the processing circuitry 409 (e.g., microcontroller) for processing and/or display through a graphical user interface, such as shown in FIG. 5B for example.

Translation of the Recorded Movements onto a Robotic Stage or Arm

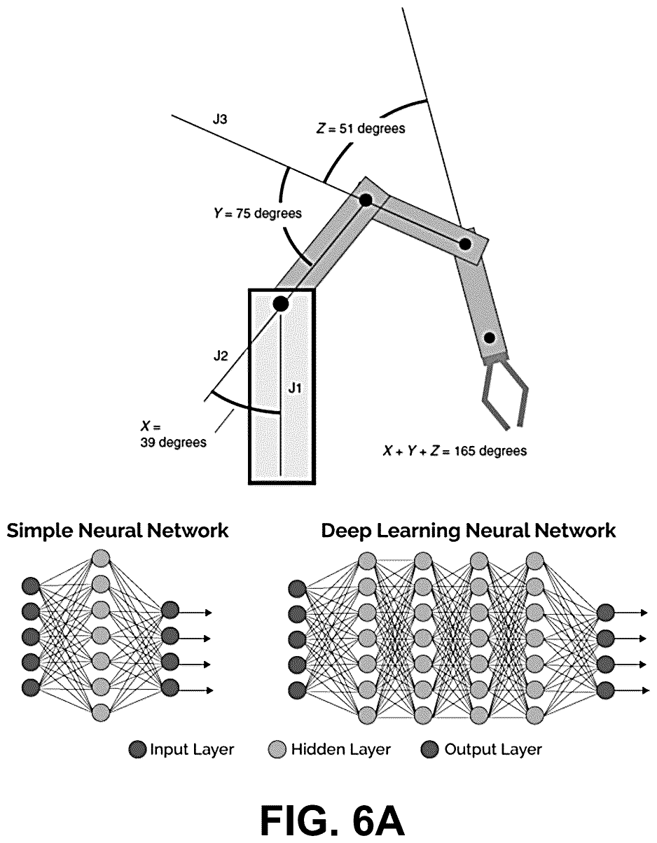

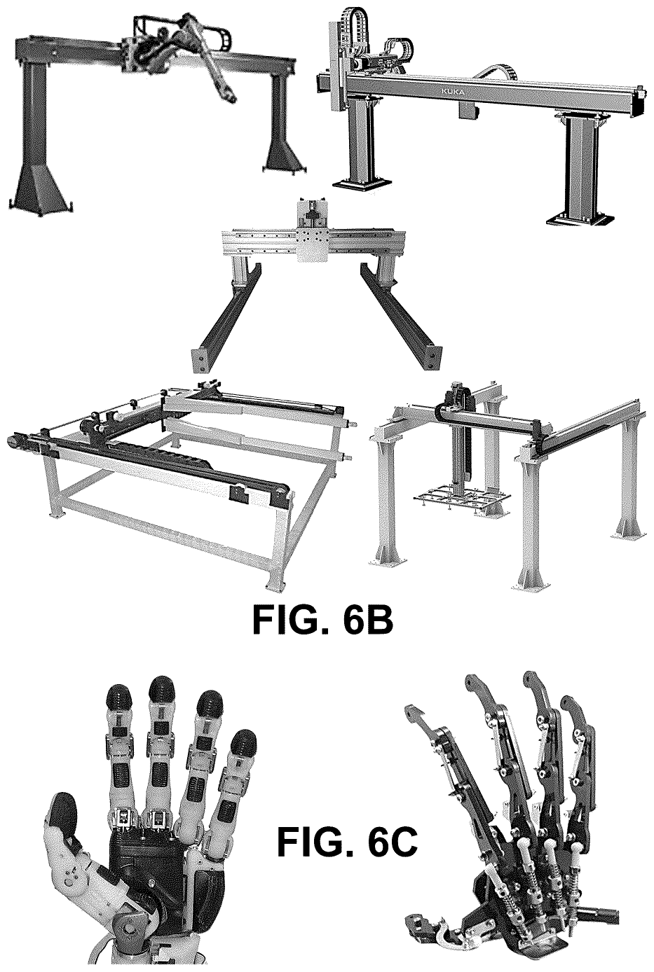

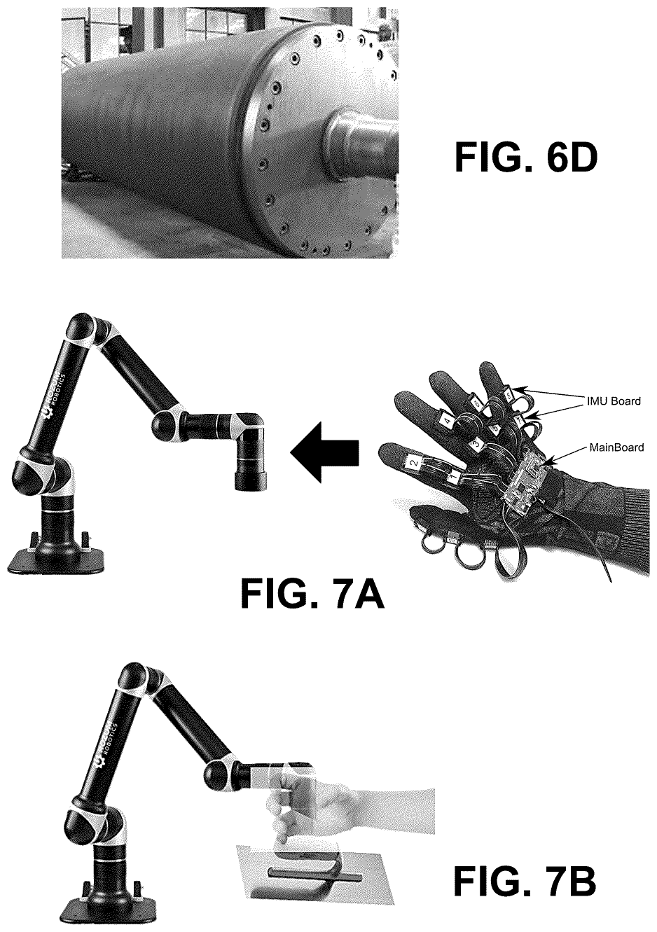

FIG. 2 shows the current paradigm of manual EIFS application (left) and an embodiment of the present disclosure of future robotic EIFS application (right). The recorded movements of the trowel operated by a human operator, skilled worker, or artistic operator as shown in FIG. 2 can be translated onto a robotic stage or arm via artificial intelligence (AI) systems, such as, e.g., artificial neural networks, single layer or multi-layer feedforward networks, recurrent networks, convolutional networks, deep learning neural networks, or other machine learning systems (FIG. 6A), or via forward kinematics, or inverse kinematics, potentially coupled with a stochastic optimization framework (see above; FIG. 3) or other multi-variate optimization algorithm or framework for robotic arm joint angle optimization. An entire deployment path for a robotic arm (i.e., a deployment trajectory as opposed to just a simple static pose of a robotic arm) can be optimized using the SOF or other methodology. See, e.g., “Dynamic Optimization of N-Joint Robotic Limb Deployments” by Fink et al. (Journal of Field Robotics, Volume 27, Issue 3, p. 268-280, 2010, DOI: 10.1002/rob.20323).

In other embodiments, a linear robotic stage, or a linear robotic stage with robotic arm, a robotic x/y stage, or a robotic x/y/z stage or gantry system as illustrated in the images of FIG. 6B, can be used to automate, e.g., the EIFS process for panels, or other applications beyond building envelope retrofits. In some cases, the end effector of the robotic arm can be a fully articulated robotic hand, emulating a human hand and its dexterity, including finger and wrist movement as illustrated in FIG. 6C. In yet another implementation, the robotic stage can be equipped with an industrial roller pin or roll press, or there can be a pre-stage with an industrial roller pin or roll press that precedes the robotic stage, as illustrated in the image of FIG. 6D, to manipulate the coating surfaces, e.g., prior to the robotic troweling. In some cases, an industrial stamp or other imprinting mechanism can be used to smoothen the coating surfaces. In yet other cases, an industrial stamp or other imprinting mechanism (similar in concept to a waffle iron) can be used to imprint a close to final texture or finish, i.e., the target or desired texture or finish, onto the coating surfaces to reduce the subsequent robotic troweling effort, e.g., in terms of time and/or number of steps. In yet some other cases, an industrial stamp or other imprinting mechanism (similar in concept to a waffle iron) can be used to imprint the final texture or finish, i.e., the target or desired texture or finish, onto the coating surfaces in which case no subsequent robotic troweling effort is needed.

### Teaching/Training a Robotic Stage/Gantry or Arm the 3D Movements of a Hand Tool

To teach/train a robotic stage/gantry or arm the 3D movements of a hand-held tool, such as, but not limited to, a trowel operated by a human operator, skilled worker, or artistic operator, in another instantiation, one can make the human operator, skilled worker, or artistic operator wear a data/sensor-glove wirelessly coupled (or coupled with a wire) to a robotic arm control system in teaching mode, as illustrated in FIG. 7A, to directly teach the robotic arm the movements of the human operator, skilled worker, or artistic operator as they perform, e.g., the application of EIFS on a panel, including “massaging” of the applied finish coating to arrive at a desired texture. This approach could circumvent the need for training of an artificial intelligence (AI) system, such as, e.g., an artificial neural network, a single layer or multi-layer feedforward network, a recurrent network, a convolutional network, a deep learning neural network, or another machine learning system, or circumvent the need for forward kinematics or inverse kinematics.

A slightly modified approach using the freedrive mode of a robotic arm is illustrated in FIG. 7B. In this mode, the user can teach a robotic arm different trajectories, 3D attitudes, orientations, and positions, etc. by moving its axes directly by hand, e.g., by holding onto the end-effector of the robotic arm, which in one instantiation could be a robotic hand as depicted in FIG. 6C or fixture with an attached trowel as depicted in FIG. 7B, and actively guiding it (i.e., the end-effector) to perform, e.g., the EIFS application on the panels. Other training approaches can be utilized.

### Teaching/Training a Robot the Motifs of Hand Tool Movement

To teach/train a robot the motifs of hand tool (e.g., trowel, carver, chisel, paint brush, spray can, coating tool, welding torch, etc.) movement, for example, a human operator, skilled human worker, or artistic operator is asked to perform certain basic trowel (or other tool) movements/motions, i.e., termed motifs. As such, complex trowel operations may be the product of a sequential and/or superposition (i.e., simultaneous) application of these motifs, i.e., basically breaking down complex trowel operations into atomic (behavior) units (i.e., motifs) just like Lego® building blocks. Examples of these motifs are, without limitation: swirling motion, stroking motion, angling, rotating, pivoting, force or pressure changes, etc. Video camera feedback of these movements/motions can be used to train an artificial intelligence (AI) system, such as, e.g., an artificial neural network, a single layer or multi-layer feedforward network, a recurrent network, a convolutional network, a deep learning neural network, or another machine learning system, or to employ forward kinematics or inverse kinematics, such that the robotic arm can replicate these basic movements/motions or motifs.

Hereby the hand of the human operator, human skilled worker, or artistic operator may be equipped with fiducial markers, similar to the movie industry when, e.g., infrared-reflective or fluorescent markers are placed on a human actor, or when wearing a motion capture suit, to capture their motion, and subsequently project/impose/superimpose/integrate the so-recorded motion onto a “monster” or other being/creature (e.g., in a computer using CGI, i.e., computer-generated imagery) to have it execute the same motion. To effectuate such movement/motion capture, IR (i.e., infrared) high-speed cameras can be used for example. In addition, either simultaneously, intermittently, or subsequently, a stereo camera or multi-camera vision system can be used to monitor/capture what the resulting effect(s) of the movements/motions or motifs are when executed/applied, e.g., the effect(s) on applying EIFS coating material on a panel with regards to texture. That way the relationship between cause and effect of individual and/or combined/superimposed atomic trowel (behavior) motifs is learned and instilled into the robotic troweling system via the trained artificial intelligence (AI) systems, such as, e.g., artificial neural networks, single layer or multi-layer feedforward networks, recurrent networks, convolutional networks, deep learning neural networks, or other machine learning systems, or via forward kinematics or inverse kinematics. In one instantiation these AI systems can be trained with a stochastic optimization framework (FIG. 3) or other multi-variate optimization algorithm or framework.

Texture Optimization with Robotic Troweling Guided by Stochastic Optimization Framework

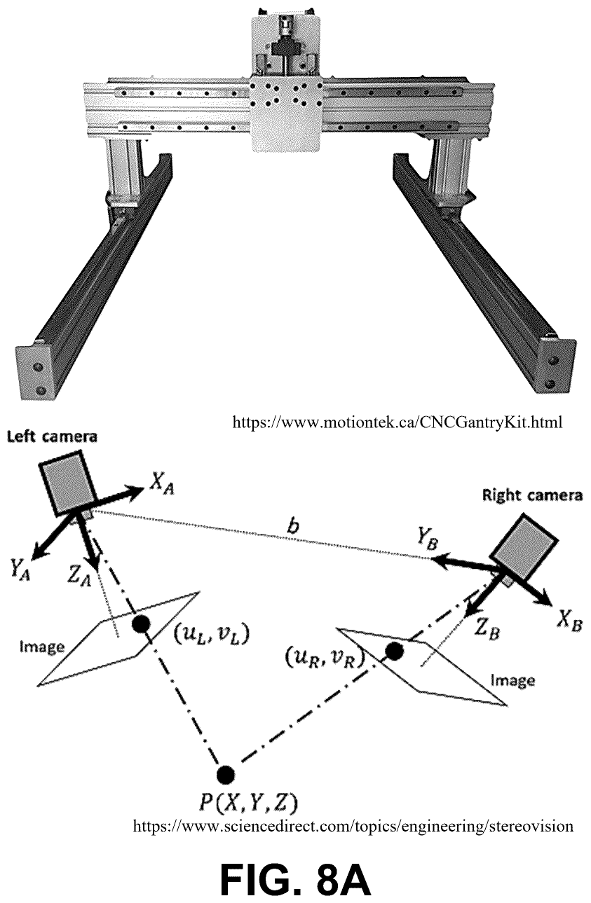

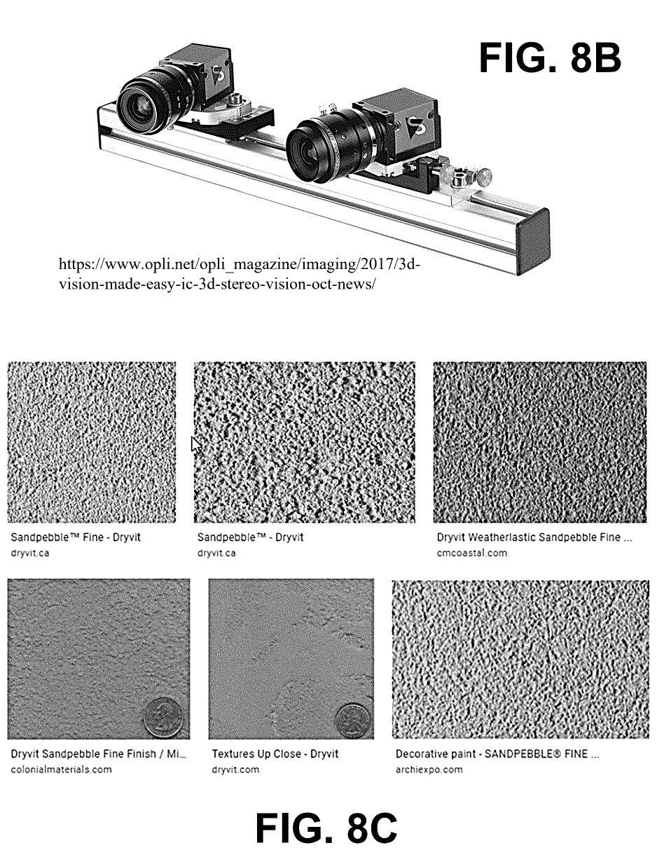

In one instantiation of the present disclosure, a robotic stage or gantry (FIG. 6B) can be equipped with, e.g., a mono-, stereo-, or multi-camera monitoring system (FIGS. 8A and 8B), to provide (real time) visual feedback to a robotic troweling system on the currently achieved texture and/or other modalities or characteristics of the (EIFS) coating across the panel. For example, texture can be determined by the application of Gabor (FIG. 8D) or other applicable/suitable filters applied to the camera images and processed, e.g., by the onboard computer of the robotic system, or another microprocessor or micro-computer, or a cloud-based computing resource, or a spatially distributed computing resource. FIG. 8C illustrates examples of wall textures that can be identified and/or are the desired end result of the troweling process—manual or robotic. In another example, surface metrology, e.g., via a 3D optical profilometer can be applied to determine texture.

Using a stochastic optimization framework (SOF; FIG. 3) or other multi-variate optimization algorithm or framework, an autonomous/reactive robotic troweling system can be created and commanded, e.g., in closed-loop fashion (i.e., autonomously or fully automatically), using constant or frequent visual feedback from the camera monitoring system (FIGS. 8A and 8B), by selecting and issuing/engaging/executing one or more of the extracted or learned troweling (behavior) motifs (as discussed above), either in sequence or simultaneously/superimposed, to manipulate the (EIFS) coating until the difference between the current/resulting texture and the target/desired texture is within a certain user-defined accuracy or tolerance. This difference is the fitness measure that drives the governing stochastic optimization framework or other multi-variate optimization algorithm or framework. In one instantiation of the present disclosure, a post-application review (i.e., after the robotic troweling effort has finished) of the achieved final texture or finish can be conducted by timely and repeated reassessments of the texture difference (i.e., the SOF fitness), to ensure texture stability, i.e., to compensate for situations in which the final, satisfactory texture or finish may have morphed/changed over time before curing of the coating material or coating surface. This can happen, for example, if the viscosity/density of the coating material is too low. In that case, and if unacceptable, i.e., outside the user-defined accuracy or tolerance, the reactive robotic troweling process (as discussed above) would reengage to correct this deviation or difference. Again, the deviation or difference between the currently achieved texture (at a given point in time) and the target/desired texture—i.e., the SOF fitness—can be determined via, e.g., Gabor (FIG. 8D) or other applicable/suitable filters applied to the camera images, 3D optical profilometry, or other surface metrology methods, by applying, e.g., the Gabor or other applicable/suitable filters to both the currently achieved texture (at a given point in time) and the target/desired texture (ideally to be done only once), and by comparing the two filter outcomes.

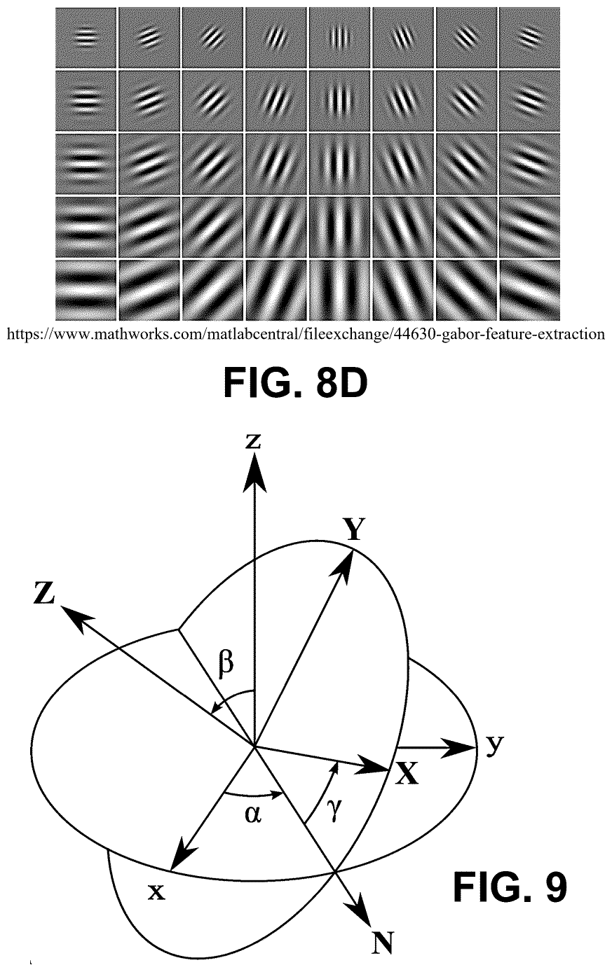

Each motif can be (mathematically) represented, for example, as an execution and/or duration time-stamped list (see example list below) comprising m≥1 particular execution or time-steps of a motif, each of duration Tᵢ (measured, e.g., in milliseconds, seconds, or minutes) with 1≤i≤m, and having (xₖ, yₖ, zₖ) translational and (αₖ, βₖ, γₖ) rotational (e.g., Euler angles; FIG. 9) movements of the n≥1 joints and/or end-effector(s) of a robotic arm (FIG. 6A, top), where k denotes the respective joint and/or end-effector of the robotic arm, with 1≤k≤n.

| | | | | | | |
|---|---|---|---|---|---|---|
| T₁ | x₁, x₂, . . . , xₙ | y₁, y₂, . . . , yₙ | z₁, z₂, . . . , zₙ | α₁, α₂, . . . αₙ | β₁, β₂, . . . , βₙ | γ₁, γ₂, . . . , γₙ |
| T₂ | x₁, x₂, . . . , xₙ | y₁, y₂, . . . , yₙ | z₁, z₂, . . . , zₙ | α₁, α₂, . . . αₙ | β₁, β₂, . . . , βₙ | γ₁, γ₂, . . . , γₙ |
| . . . | . . . | . . . | . . . | . . . | . . . | . . . |
| Tᵢ | x₁, x₂, . . . , xₙ | y₁, y₂, . . . , yₙ | z₁, z₂, . . . , zₙ | α₁, α₂, . . . αₙ | β₁, β₂, . . . , βₙ | γ₁, γ₂, . . . , γₙ |
| . . . | . . . | . . . | . . . | . . . | . . . | . . . |
| Tₘ | x₁, x₂, . . . , xₙ | y₁, y₂, . . . , yₙ | z₁, z₂, . . . , zₙ | α₁, α₂, . . . αₙ | β₁, β₂, . . . , βₙ | γ₁, γ₂, . . . , γₙ |

Such a list, in another example, can comprise fewer or additional columns in which, e.g., force or exerted/applied pressure values for each joint and/or end-effector of the robotic arm are described and/or listed for each execution time step/duration within a motif. Such force or pressure values can also be implied, i.e., they can be the physical result of the respective (xₖ, yₖ, zₖ) translational and (αₖ, βₖ, γₖ) rotational movements of the joints and/or end-effector(s) of the robotic arm at any given time-step.

Also, it should be noted that in each time-step, one or more joints and/or end-effector(s) can be manipulated simultaneously.

In the above or in a similar fashion, previously extracted or learned motifs (see, e.g., “Teaching/Training a Robot the Motifs of Hand Tool Movement” above) can be represented in the form of such execution and/or duration time-stamped lists. As such, the Autonomous/Reactive Human-Robotic Mimetic Haptic Control Framework, for example via a stochastic optimization framework (SOF; FIG. 3) or other multi-variate optimization algorithm or framework, is now enabled to perform the following (listed in no particular order):
Partial execution of a motif:
   For example, execute only T₁ through Tⱼ, i.e., only the first j time steps out of the total duration sum(T₁, . . . , Tₘ) for a given motif, with 1≤j≤m.
   For example, execute only Tᵢ through Tⱼ, i.e., the inner (j−i+1) time steps out of the total duration sum(T₁, . . . , Tₘ) for a given motif, with 1≤i≤j<m.
   For example, execute only Tₘ₋ⱼ through Tₘ, i.e., the final (j+1) time steps out of the total duration sum(T₁, . . . , Tₘ) for a given motif, with 0≤j≤m−1.
Speed-up or slow-down of an entire motif or parts of a motif:
   For example, by multiplying T₁ through Tₘ with a common factor λ, where 0<λ<1 results in a speed-up, and λ>1 in a slow-down.
   For example, by multiplying one or more selected Tᵢ segments with a common factor λ, where 0<λ<1 results in a speed-up, and λ>1 in a slow-down of these one or more selected Tᵢ segments of the motif.
   For example, by multiplying one or more selected Tᵢ segments with a respective/individual Tᵢ segment-specific factor λᵢ, where 0<λᵢ<1 results in a speed-up, and λᵢ>1 in a slow-down of the respective one or more selected Tᵢ segments of the motif.
   λ=0 when applied to one or more selected Tᵢ segments would result in their elimination, which can also be used for motif truncation or reduction.
Inversion of a motif:
   For example by reversing the order of time steps from (T₁ . . . Tₘ) to (Tₘ . . . T₁).
   For example by reversing the order of one or more subsets of time steps within (T₁ . . . Tₘ) of a motif.
Any combination of the above.

The above gives rise to more advanced capabilities, such as, but not limited to:
Mixing or blending of two or more motifs:
   For example, the first j time steps of motif A can be replaced with the first i time steps of same or different duration of another motif B to result in a mixed/blended modified/new motif.
   For example, the inner (j−i+1) time steps of motif A can be replaced with an inner section of same or different duration of another motif B to result in a mixed/blended modified/new motif, with j>i.
   For example, the final (j+1) time steps of motif A can be replaced with the final (i+1) time steps of same or different duration of another motif B to result in a mixed/blended modified/new motif.
   More generally: an arbitrary set of time steps (consecutive/contiguous or not) of motif A can be replaced with an arbitrary set of time steps of same or different duration of another motif B, or arbitrary time steps of multiple different motifs to result in a mixed/blended modified/new motif.
   Any combination of the above.

The above new capabilities lay the foundation for and/or are ideally suited for the use of Stochastic Optimization Frameworks (FIG. 3), utilizing as optimization engines algorithms or algorithm groups, such as, but not limited to:
Simulated Annealing (SA; e.g., (1) N. Metropolis, A. W. Rosenbluth, M. N. Rosenbluth, A. H. Teller, E. Teller, Equation of State Calculation by Fast Computing Machines, J. of Chem. Phys., 21, 1087-1091, 1953; (2) S. Kirkpatrick, C. D. Gelat, M. P. Vecchi, Optimization by Simulated Annealing, Science, 220, 671-680, 1983);
Genetic Algorithms (GAs; e.g., (1) J. H. Holland, Adaptation in Natural and Artificial Systems, The University of Michigan Press, Ann Arbor, Michigan, 1975; (2) D. E. Goldberg, Genetic Algorithms in Search, Optimization and Machine Learning. Addison-Wesley, 1989) with point mutation, cross-over, and inversion operators; or
Evolutionary Algorithms (EAs; generalizations, extensions, expansions, modifications, variants, etc. of GAs);
   to generate/create (e.g., through algorithm-typical operations such as, but not limited to, point mutation (SA, GA, EA), crossover (GA and EA), and inversion (GA and EA)) brand new motifs and/or a library/libraries of new motifs (a) based on the previously extracted or learned motifs (see, e.g., “Teaching/Training a Robot the Motifs of Hand Tool Movement” above), or (b) even from scratch (i.e., ab initio) by generating the respective execution and/or duration time-stamped list for each motif via a stochastic optimization framework (SOF; FIG. 3) or other multi-variate optimization algorithm or framework. The effect of such new motifs can be tested/observed, e.g., through the constant or frequent visual feedback from the camera monitoring system (FIGS. 8A and 8B; see, e.g., “Texture Optimization with Robotic Troweling guided by Stochastic Optimization Framework” above) during their execution, respectively. This feedback, in particular, enables (b), i.e., the ab initio generation/creation of motifs.

The following non-exhaustive list shows examples of some modalities or characteristics and how they can be assessed, measured, observed, monitored, or recorded:
Thickness, evenness or smoothness of coating across the panel as a function of location, monitored or measured, e.g., via ultrasound sensing (Ultrasonic Thickness Measurement (UTM)), chromatic confocal sensors, and thickness measurement techniques based on distance triangulation computation of a laser beam, etc.;
Moisture or humidity content of coating across the panel as a function of location, monitored or measured, e.g., via moisture or humidity sensing elements, time-domain reflectometers (TDRs), volumetric water content sensors, neutron probes, etc.;
Temperature distribution across the panel as a function of location, monitored or measured, e.g., via RTD (Resistance Temperature Detector), thermocouples, thermistors, IC sensors, thermometer, infrared thermometers, infrared scanners, and pyrometers, etc.
Viscosity or density across the panel as a function of location, monitored or measured, e.g., via viscometers (these work, e.g., by actuating a tiny piston to hit the material and measure the resistance to the hit), such as the Cambridge Viscosity's Miniature Viscometer 501, and/or indentation densitometers (these work, e.g., by measuring the force, i.e., the applied load value, for a given indentation depth by means of a displacement sensor), etc.

In addition to building envelope retrofitting, the autonomous/reactive human-robotic mimetic haptic control framework can be applied to applications comprising, but not limited to:
Building brick walls: Here the autonomous/reactive human-robotic mimetic haptic control framework would be used to train behavior motifs comprising masonry techniques or stonework techniques corresponding to stapling of bricks/stones, spatial arrangement of bricks/stones, leveling of bricks/stones, application of mortar, evenness of mortar application, etc.
Molding (e.g., clay): Here the autonomous/reactive human-robotic mimetic haptic control framework would be used to train behavior motifs comprising molding or shape-changing techniques, etc. corresponding to, e.g., evenness/smoothness or thickness of applied material (e.g. clay, etc.). Molding or shape-changing techniques can comprise elements, such as, but not limited to: directionality, force or pressure, etc.
Carving or chiseling (e.g., wood, stone, ice, etc.): Here the autonomous/reactive human-robotic mimetic haptic control framework would be used to train behavior motifs comprising wood carving or stone/ice chiseling techniques, etc. Carving/chiseling techniques can comprise elements, such as, but not limited to: carving/chiseling directionality, carving/chiseling force or pressure, carving/chiseling frequency, carving/chiseling angle of attack with respect to surface to be carved/chiseled, etc.
Industrial and artistic painting: Here the autonomous/reactive human-robotic mimetic haptic control framework would be used to train behavior motifs comprising certain stroke techniques corresponding to the application of paint to surfaces. Stroke techniques can comprise elements, such as, but not limited to: stroke force or pressure, amount/thickness of paint, stroke frequency, stroke directionality, evenness/smoothness, color choice, mixture of colors, etc.
Spraying/coating: Here the autonomous/reactive human-robotic mimetic haptic control framework would be used to train behavior motifs comprising certain spray/coating techniques corresponding to, e.g., frequency of application which would determine the thickness of the spray-applied material or coating, directionality, evenness/smoothness, spray/coating choice, mixture of sprays/coatings, etc.
Welding: Here the autonomous/reactive human-robotic mimetic haptic control framework would be used to train behavior motifs comprising certain welding techniques corresponding to, e.g., application of solder/braze (if any), angle of torch with respect to soldering area, duration of soldering in a particular location within the soldering area, etc.

The above and other applications comprising manually executed tasks that can be copied/emulated/mimicked and executed by the autonomous/reactive human-robotic mimetic haptic control framework can be envisioned not only on Earth (including on the surface, in the subsurface (e.g., caves), in liquid environments (e.g., oceans, lakes, rivers), in the air), but also in space and on other planetary bodies, such as the Moon, Mars, asteroids, comets, etc., as well as on extra-terrestrial ocean worlds, such as Europa and Titan, etc.

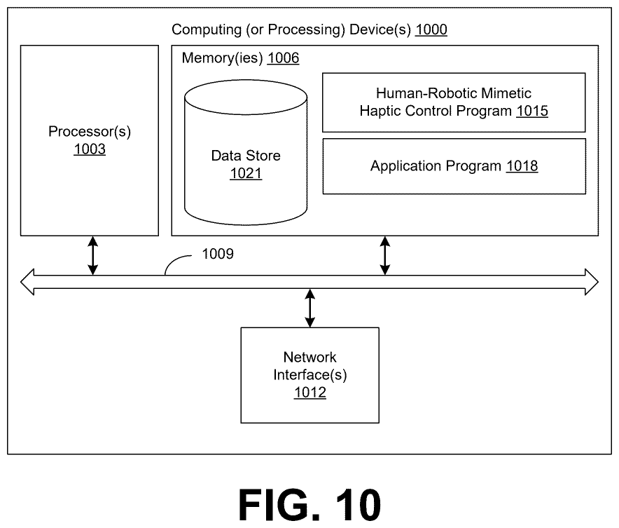

FIG. 10 is a schematic diagram illustrating an example of a computing (or processing) device 1000 that can be used for the autonomous/reactive human-robotic mimetic haptic control framework or other applications, in accordance with various embodiments of the present disclosure. The computing (or processing) device 1000 can comprise one or more computing/processing devices such as, e.g., a smartphone, tablet, computer, controller, etc. The computing (or processing) device 1000 can include processing circuitry comprising at least one processor circuit, for example, having a processor 1003 and a memory 1006, both of which are coupled to a local interface 1009. To this end, each computing (or processing) device 1000 may comprise, for example, at least one server computer or like device, which can be utilized locally or in a cloud-based environment or (spatially) distributed environment. The local interface 1009 may comprise, for example, a data bus with an accompanying address/control bus or other bus structure as can be appreciated.

In some embodiments, the computing (or processing) device 1000 can include one or more network interfaces 1012 for communication with various devices and systems such as, e.g., the hand tool (e.g., trowel 403) or a robotic system. The network interface 1012 may comprise, for example, a wireless transmitter, a wireless transceiver, and/or a wireless receiver. The network interface 1012 can communicate to a remote computing/processing device or other components using a Bluetooth, WiFi, or other appropriate wireless protocol. As one skilled in the art can appreciate, other wireless or optical protocols may be used in the various embodiments of the present disclosure. The network interface 1012 can also be configured for communications through wired connections.

Stored in the memory 1006 are both data and several components that are executable by the processor(s) 1003. In particular, stored in the memory 1006 and executable by the processor 1003 can be an autonomous/reactive human-robotic mimetic haptic control application 1015 which can utilize the most significant cell methodology as disclosed herein, and potentially other applications 1018. In this respect, the term “executable” means a program file that is in a form that can ultimately be run by the processor(s) 1003. Also stored in the memory 1006 may be a data store 1021 and other data. In addition, an operating system may be stored in the memory 1006 and executable by the processor(s) 1003. It is understood that there may be other applications that are stored in the memory 1006 and are executable by the processor(s) 1003 as can be appreciated.

Examples of executable programs may be, for example, a compiled program that can be translated into machine code in a format that can be loaded into a random access portion of the memory 1006 and run by the processor(s) 1003, source code that may be expressed in proper format such as object code that is capable of being loaded into a random access portion of the memory 1006 and executed by the processor(s) 1003, or source code that may be interpreted by another executable program to generate instructions in a random access portion of the memory 1006 to be executed by the processor(s) 1003, etc. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, B#, Rust, Lua, Verilog, MATLAB/Simulink, Go, Assembly, or one or more other embedded or general purpose programming languages.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), non-volatile random access memory (NVRAM), synchronous dynamic random access memory (SDRAM), high-bandwidth memory (HBM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and/or multiple processor cores, and the memory 1006 may represent multiple memories 1006 that operate in parallel processing circuits, respectively. In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, ultrasound or other devices. The processor 1003 may be of electrical or of some other available construction.

Although the autonomous/reactive human-robotic mimetic haptic control application 1015, and other various applications 1018 described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the autonomous/reactive human-robotic mimetic haptic control application 1015, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, optical discs, or crystal or holographic storage. Also, the computer-readable medium may be a random access memory (RAM) including, for example, static random access memory (SRAM) and dynamic random access memory (DRAM), non-volatile random access memory (NVRAM), synchronous dynamic random access memory (SDRAM), high-bandwidth memory (HBM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the autonomous/reactive human-robotic mimetic haptic control application 1015, may be implemented and structured in a variety of ways. For example, one or more applications described may be implemented as modules or components of a single application. For example, the autonomous/reactive human-robotic mimetic haptic control application 1015 can include a wide range of modules such as, e.g., an initial model or other modules that can provide specific functionality for the disclosed methodology. Further, one or more applications described herein may be executed in shared or separate computing/processing devices or a combination thereof. For example, a plurality of the applications described herein may execute in the same computing (or processing) device 1000, or in multiple computing/processing devices in the same computing environment. To this end, each computing (or processing) device 1000 may comprise, for example, at least one server computer or like device, which can be utilized locally or in a cloud-based environment or (spatially) distributed environment.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A system for autonomous/reactive human-robotic mimetic haptic control, comprising:
at least one sensor obtaining tool operation data associated with a user operating a hand tool during execution of a construction process; and
at least one computing device configured to:
train a robotic system to mimic operation of the hand tool based upon the tool operation data; and
cause the robotic system to carry out the operation using the hand tool by performing at least a portion of one or more trained behavior motif, each trained behavior motif comprising a time-stamped list of defined execution steps.

2. The system of claim 1, wherein at least a portion of a first trained behavior motif is performed, and a portion of a second trained behavior motif is performed.

3. The system of claim 2, wherein the portion of the first trained behavior motif is a first portion of the first trained behavior motif and the portion of the second trained behavior motif is a second portion of the second trained behavior motif.

4. The system of claim 2, wherein the portion of the first trained behavior motif is a first portion of the first trained behavior motif and the portion of the second trained behavior motif is a first portion of the second trained behavior motif.

5. The system of claim 2, wherein the portion of the first trained behavior motif is executed at a first speed and the portion of the second trained behavior motif is executed at a second speed.

6. The system of claim 1, wherein discontinuous portions of one or more trained behavior motif are performed.

7. The system of claim 1, wherein at least a portion of a first trained behavior motif is inverted prior to being performed.

8. The system of claim 1, wherein one or more portion of the first trained behavior motif is exchanged with one or more portion of the second trained behavior motif.

9. The system of claim 8, wherein the exchanged portions are not in corresponding positions in the first and second trained behavior motifs.

10. The system of claim 8, wherein at least one of the exchanged portions is reordered in at least one of the first and second trained behavior motifs.

11. The system of claim 1, wherein the at least one computing device is configured to:
identify a behavior motif associated with movement or motion of the hand tool during execution of the operation based upon the tool operation data; and
train the robotic system to execute the behavior motif using the hand tool.

12. The system of claim 11, wherein the behavior motif comprises movement of the hand tool in three dimensions over a period of time.

13. The system of claim 11, wherein execution of the behavior motif comprises application of a pressure or force through the hand tool.

14. The system of claim 1, wherein the at least one computing device is configured to:
identify at least a portion of one or more behavior motifs associated with movement or motion of the hand tool during execution of the operation based upon the tool operation data; and
train the robotic system to execute the at least a portion of one or more behavior motifs using the hand tool.

15. The system of claim 1, wherein the operation comprises application of a surface coating.

16. The system of claim 15, wherein the at least a portion of one or more trained behavior motif is modified in response to a comparison of at least a current modality or characteristic of the surface coating with a target modality or characteristic of the surface coating.

17. The system of claim 16, wherein the modification of the at least a portion of one or more trained behavior motif is effectuated using a stochastic optimization framework.

18. The system of claim 16, comprising a monitoring system configured to provide feedback for the comparison, the feedback associated with a modality or characteristic of the surface coating.

19. The system of claim 1, wherein the at least a portion of one or more trained behavior motif is modified in response to a comparison of at least a current modality or characteristic of the construction process with a target modality or characteristic of the construction process.

20. The system of claim 19, comprising a monitoring system configured to provide feedback for the comparison, the feedback associated with a modality or characteristic of the construction process.
